(19) United States
(12) Patent Application Publication
(10) Pub. No.: US 2025/0323294 A1
(43) Pub. Date: Oct. 16, 2025

(54) Vehicle Control Apparatus and Method Thereof

(71) Applicants: Hyundai Motor Company, Seoul (KR); Kia Corporation, Seoul (KR)

(72) Inventors: Min Gu Park, Hwaseong-Si (KR); Jun Su Lee, Hwaseong-Si (KR)

(21) Appl. No.: 18/925,861

(22) Filed: Oct. 24, 2024

(30) Foreign Application Priority Data
Apr. 12, 2024 (KR) 10-2024-0049519

(51) Int. Cl. H01M 8/0438; B60R 16/03; H01M 8/04111; H01M 8/0432; H01M 8/04664; H01M 8/04746

(52) U.S. Cl. CPC H01M 8/04395; H01M 8/04111; H01M 8/04358; H01M 8/04373; H01M 8/04425; H01M 8/04686; H01M 8/04776; B60R 16/0307; H01M 2250/20

(57) ABSTRACT

A vehicle control apparatus may identify a first sensing value for measuring a flow rate of air corresponding to a first RPM while the air is supplied to a fuel cell stack from an outside of the vehicle control apparatus by driving an air compressor based on the first RPM, obtain a first amount of change in a temperature of a coolant flowing using a cooler and a second amount of change in a temperature of the air compressor during a first time during which the air compressor is driven based on the first RPM, obtain a first flow rate value representing the flow rate of the air supplied to the fuel cell stack by using the first amount of change in the temperature of the coolant and the second amount of change in the temperature of the air compressor.

### CROSS-REFERENCE TO RELATED APPLICATION

This application claims the benefit of priority to Korean Patent Application No. 10-2024-0049519, filed in the Korean Intellectual Property Office on Apr. 12, 2024, the entire contents of which are incorporated herein by reference.

### TECHNICAL FIELD

The present disclosure relates to a vehicle control apparatus and a method thereof, and more particularly, to technology for tuning a flow rate value and a sensing value.

### BACKGROUND

In general, a fuel cell, which converts the energy contained in a fuel into electrical energy, may include an electrolyte arranged between a cathode and an anode to cause oxidation of hydrogen at the anode and reduction of oxygen at the cathode, thereby generating electricity and heat together. Because the output of the fuel cell is controlled according to the flow rate of oxygen supplied to the fuel cell, tuning of a flow rate sensor may be necessary, for example, if an air intake system for supplying oxygen to the fuel cell is replaced. Therefore, there is a need to study a scheme of tuning a flow rate sensor to accurately measure the flow rate of oxygen supplied to a fuel cell.

### SUMMARY

The following summary presents a simplified summary of certain features. The summary is not an extensive overview and is not intended to identify key or critical elements.

Systems, apparatuses, and methods are described for a vehicle control apparatus. A vehicle control apparatus may comprise: one or more processors; a memory storing instructions; a fuel cell stack; an air compressor; a temperature sensor; and a flow rate sensor. The instructions, when executed by the one or more processors, may configure the one or more processors to: determine, based on first data, from the flow rate sensor, associated with air supplied to the fuel cell stack via the air compressor driven at a first revolutions per minute (RPM) during a first time, a first sensing value for measuring a flow rate of air and corresponding to the first RPM; determine, based on second data, from the temperature sensor, collected during the first time: a first amount of change in a temperature of a coolant flowing via a cooler, and a second amount of change in a temperature of the air compressor; determine, based on the first amount of change in the temperature of the coolant and the second amount of change in the temperature of the air compressor, a first flow rate value representing the flow rate of the air supplied to the fuel cell stack; and map the first sensing value to the first flow rate value.

Also, or alternatively, A method may comprise: determining, by a vehicle control apparatus based on first data, from a flow rate sensor, associated with air supplied to a fuel cell stack via an air compressor driven at a first revolutions per minute (RPM) during a first time, a first sensing value for measuring a flow rate of air corresponding to the first RPM; determining, based on second data, from a temperature sensor, collected during the first time: a first amount of change in a temperature of a coolant flowing via a cooler, and a second amount of change in a temperature of the air compressor; determining, based on the first amount of change in the temperature of the coolant and the second amount of change in the temperature of the air compressor, a first flow rate value representing the flow rate of the air supplied to the fuel cell stack; mapping the first sensing value to the first flow rate value; and controlling, by the vehicle control apparatus based on the mapping of the first sensing value to the first flow rate value, air flow, to the fuel cell stack, via the air compressor.

These and other features and advantages are described in greater detail below.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating an example of a vehicle control apparatus according to an example of the present disclosure;

FIG. 2 is a diagram illustrating an example of an operation of identifying a flow rate value using a temperature sensor by a vehicle control apparatus according to an example of the present disclosure;

FIG. 3 is a block diagram illustrating an example of a hardware configuration included in a vehicle control apparatus according to an example of the present disclosure;

FIG. 4 is a diagram illustrating an example of a screen for a vehicle control apparatus according to an example of the present disclosure to initiate an operation of mapping a flow rate value and a sensing value;

FIG. 5 is a diagram illustrating graphs of an example of an operation of mapping a sensing value and a flow rate value while a vehicle control apparatus according to an example of the present disclosure drives an air compressor at a specified RPM;

FIG. 6 is a diagram illustrating graphs of an example of an operation of mapping a sensing value and a flow rate value while a vehicle control apparatus according to an example of the present disclosure drives an air compressor based on a no-load state;

FIG. 7 is a diagram illustrating an example of a graph showing a result of mapping a sensing value and a flow rate value by a vehicle control apparatus according to an example of the present disclosure;

FIGS. 8A and 8B are flowcharts illustrating an example of an operation of a vehicle control apparatus according to an example of the present disclosure;

FIGS. 9A and 9B are flowcharts illustrating an example of an operation of a vehicle control apparatus according to an example of the present disclosure;

FIG. 10 is a flowchart illustrating an example of a vehicle control method according to an example of the present disclosure; and

FIG. 11 is a block diagram illustrating a computing system related to a vehicle control apparatus or a method of controlling a vehicle according to an example of the present disclosure.

### DETAILED DESCRIPTION

Hereinafter, some examples of the present disclosure will be described in detail with reference to the exemplary drawings. In adding the reference numerals to the components of each drawing, it should be noted that the identical or equivalent component is specified by the identical numeral throughout the drawings. Further, in describing the example of the present disclosure, a detailed description of the related known configuration or function will be omitted if it is determined that it interferes with the understanding of the example of the present disclosure.

In addition, terms, such as first, second, A, B, (a), (b) or the like may be used herein in describing components of the present disclosure. The terms are provided only to distinguish the elements from other elements, and the essences, sequences, orders, and numbers of the elements are not limited by the terms. In addition, unless defined otherwise, all terms used herein, including technical or scientific terms, have the same meanings as those generally understood by those skilled in the art to which the present disclosure pertains. The terms defined in the generally used dictionaries should be construed as having the meanings that coincide with the meanings of the contexts of the related technologies, and should not be construed as ideal or excessively formal meanings unless clearly defined in the specification of the present disclosure.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. According to an example, the module may be implemented in a form of an application-specific integrated circuit (ASIC). According to various examples, operations performed by the module, the program, or another component may be carried out sequentially, in parallel, or repeatedly, or one or more of the operations may be executed in a different order or omitted, or one or more other operations may be added.

Various examples as set forth herein may be implemented as software (e.g., program) including one or more instructions that are stored in a storage medium (e.g., an internal memory or an external memory) that is readable by a machine (e.g., a vehicle control apparatus 100). For example, a processor (e.g., a processor 110) of the machine (e.g., the vehicle control apparatus 100) may invoke at least one of the one or more instructions stored in the storage medium, and execute it. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

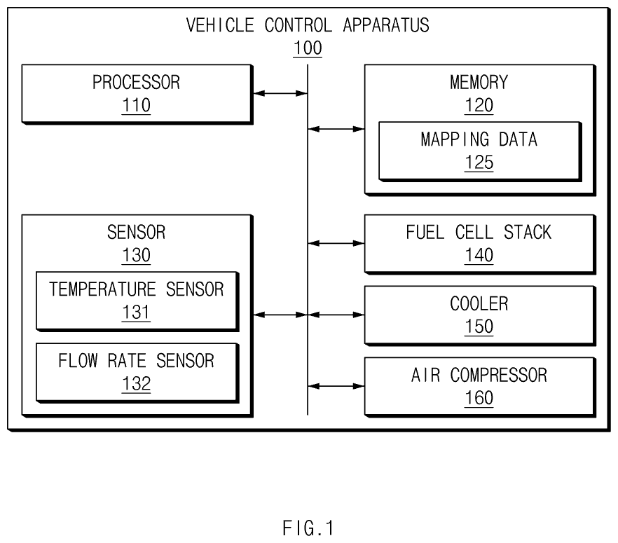

Hereinafter, examples of the present disclosure will be described in detail with reference to FIGS. 1 to 11.

FIG. 1 is a block diagram illustrating an example of a vehicle control apparatus according to an example of the present disclosure.

Referring to FIG. 1, the vehicle control apparatus 100 according to an example of the present disclosure may be implemented inside and/or outside a vehicle. Some of the components included in the vehicle control apparatus 100 may be implemented inside and/or outside the vehicle. The vehicle control apparatus 100, or some components thereof, may be formed integrally with internal control devices of the vehicle, or may be implemented as a separate device(s) and/or connected to the control devices of the vehicle via a separate connection device/protocol (e.g., via wired and/or wireless communication). For example, the vehicle control apparatus 100 may further include components not shown in FIG. 1.

The vehicle control apparatus 100 according to an example may include at least one of the processor 110, a memory 120, a sensor 130, a fuel cell stack 140, a cooler 150, or an air compressor 160. The processor 110, the memory 120, the sensor 130, the fuel cell stack 140, the cooler 150, and/or the air compressor 160 may be electrically, communicably, and/or operably coupled to each other via electronic components such as a communication bus. Hereinafter, hardware being operably/communicably coupled may mean that a direct connection or an indirect connection between the hardware is established wired or wirelessly, such that second hardware is controlled by first hardware among the hardware. Although shown as different blocks, the example is not limited thereto, and some of the hardware in FIG. 1 (e.g., at least a portion of the processor 110, the memory 120, and a communication circuit (not shown)) may be included in a single integrated circuit, such as a system on chip (SoC).

The processor 110 of the vehicle control apparatus 100 according to an example may include a hardware component for processing data based on one or more instructions. For example, hardware components for processing data may include an arithmetic and logic unit (ALU), a floating point unit (FPU), a field programmable gate array (FPGA), a central processing unit (CPU), a micro controller unit (MCU), and/or an application processor (AP). The number of processors 110 may be one or more. For example, the processor 110 may have the structure of a multi-core processor including dual cores, quad cores, hexa cores, or octa cores.

The memory 120 of the vehicle control apparatus 100 according to an example may include a hardware component for storing data and/or instructions input and/or output to the processor 110. For example, the memory 120 may include a volatile memory such as a random-access memory (RAM) and/or a non-volatile memory such as a read-only memory (ROM). For example, the volatile memory may include at least one of a dynamic RAM (DRAM), a static RAM (SRAM), a cache RAM, and a pseudo SRAM (PSRAM). For example, the non-volatile memory may include at least one of a programmable ROM (PROM), an erasable PROM (EPROM), an electrically erasable PROM (EEPROM), a flash memory, a hard disk, compact disk, and an embedded multi-media card (eMMC). The processor 110 and/or the memory 120 may be associated with a fuel cell system for controlling a fuel cell and/or managing temperature.

The fuel cell stack 140 of the vehicle control apparatus 100 according to an example may include an anode and a cathode. For example, hydrogen may be supplied to the anode of the fuel cell stack 140, causing oxidation of hydrogen. For example, oxygen may be supplied to the cathode of the fuel cell stack 140, causing reduction of oxygen. For example, the fuel cell stack 140 may include components for generating electricity by reacting hydrogen and oxygen. However, examples of the present disclosure are not limited to the above.

The cooler 150 of the vehicle control apparatus 100 according to an example may be related to (e.g., part of or comprise) a thermal management system (TMS) for managing the temperature of the fuel cell stack 140. The thermal management system may include a coolant line, a pump, and a temperature sensor to maintain a specified reaction temperature within the fuel cell stack. For example, the vehicle control apparatus 100 may adjust (or manage) the temperature of the fuel cell stack 140 by supplying the coolant to the fuel cell stack 140 by using the cooler 150.

For example, the cooler 150 may include a coolant tank for storing coolant, a coolant pump for supplying the coolant to the fuel cell stack 140, and/or a temperature sensor (e.g., a temperature sensor 131) for identifying the temperature of the coolant.

The air compressor 160 of the vehicle control apparatus 100 according to an example may be related to an air processing system (APS) or an air intake system for supplying air (or oxygen) to the fuel cell stack 140. The APS (or an air intake system) may include a compressor for compressing and introducing air from an outside of the vehicle control apparatus 100, a filter, and a flow rate sensor (e.g., a flow rate sensor 132) for identifying the flow rate of an inflow air, and/or a humidifier.

The sensor 130 of the vehicle control apparatus 100 according to an example may generate electrical information to be processed by the processor 110 and/or the memory 120 of the vehicle control apparatus 100 based on non-electronic information related to the vehicle control apparatus 100. For example, the vehicle control apparatus 100 may use the sensor 130 to measure the temperature and/or flow rate associated with the fuel cell system. There may be more than one sensor 130. As an example, the sensor 130 may be a temperature sensor for identifying (e.g., measuring) the temperature inside the vehicle control apparatus 100, a flow rate sensor for identifying (e.g., measuring) the flow rate of air, and/or a pressure sensor for identifying (e.g., measuring) the pressure inside the vehicle control apparatus 100.

For example, if the air compressor 160 is driven, the temperature sensor 131 may be used to identify the temperature inside the air compressor 160 caused by driving the air compressor 160.

For example, if the cooler 150 is driven, the temperature sensor 131 may be used to identify the temperature of the fuel cell stack 140 and/or the temperature of the coolant provided to the fuel cell stack 140.

For example, if the air compressor 160 is driven, the flow rate sensor 132 may be used to identify (or measure) the flow rate of air supplied to the fuel cell stack 140 from an outside of the vehicle control apparatus 100. The flow rate sensor 132 may be arranged relatively adjacent to an outside of the vehicle control apparatus 100 of the fuel cell stack 140 and the outside of the vehicle control apparatus 100.

For example, the flow rate sensor 132 may be arranged relatively adjacent to an outside (e.g., the inlet of the air intake system) of the vehicle control apparatus 100 of the fuel cell stack 140 and/or the outside of the vehicle control apparatus 100 to avoid the influence of the air compressor and/or high humidity.

For example, if the flow rate sensor 132 is arranged adjacent to the fuel cell stack 140, the accuracy of sensing data obtained by using the flow rate sensor 132 may be affected by the air flowing into the fuel cell stack 140. For example, air flowing into the fuel cell stack 140 from the outside of the vehicle control apparatus 100 to the fuel cell stack 140 (e.g., through a humidifier within the vehicle control apparatus 100) may result in the air may having relatively high humidity.

For example, if the flow rate sensor 132 is arranged adjacent to the fuel cell stack 140 and the fuel cell system is first driven at a relatively low outside temperature, ice formation caused by the driving of the humidifier may cause damage to the flow rate sensor 132.

That is, if the flow rate sensor 132 is arranged relatively adjacent to the outside of the vehicle control apparatus 100 of the fuel cell stack 140 and the outside of the vehicle control apparatus 100, it is possible to prevent the flow rate sensor 132 from being damaged or to reduce the influence of air flowing into the fuel cell stack 140 on the sensing data of the flow rate sensor 132.

For example, because the flow rate of air is affected by the temperature (e.g., the temperature of the air compressor 160 and/or the temperature of the coolant) and/or the shape of the air intake system, the sensing value, which represents the flow rate, of air, identified and/or measured by the flow rate sensor 132 arranged relatively adjacent to the outside of the vehicle control apparatus 100 rather than to the fuel cell stack 140, may be different from the flow rate value indicating the flow rate of air supplied to the fuel cell stack 140.

For example, because there is a difference between the sensing value and the flow rate value, the vehicle control apparatus 100 may use mapping data 125 that maps the flow rate value and the sensing value to infer the flow rate value based on the sensing value.

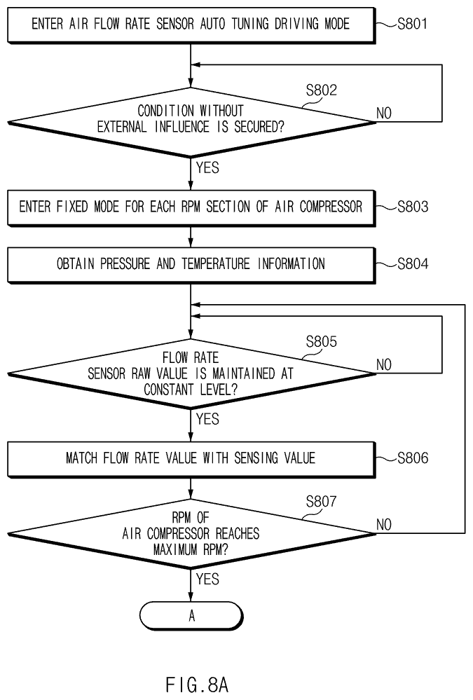

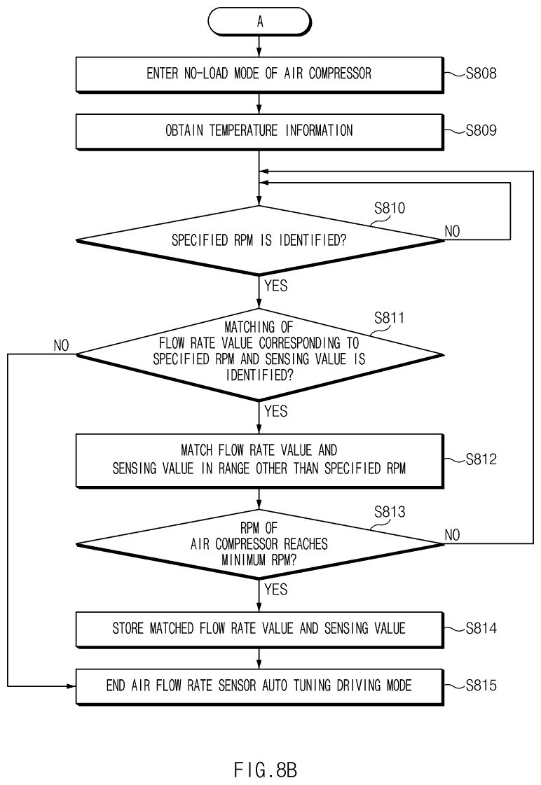

The vehicle control apparatus 100 according to an example may perform an operation of mapping (and/or tuning) the sensing value and the flow rate value based on a first time the air intake system including the air compressor 160 is coupled to the vehicle control apparatus 100. The above-described operations performed by the vehicle control apparatus 100 will be described in more detail later with reference to FIG. 8.

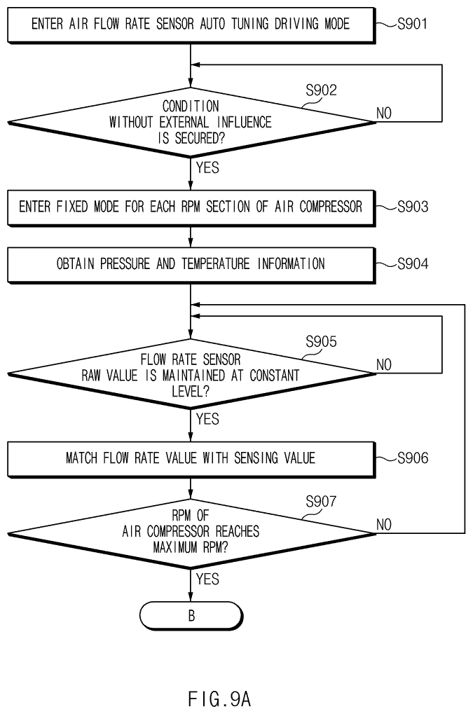

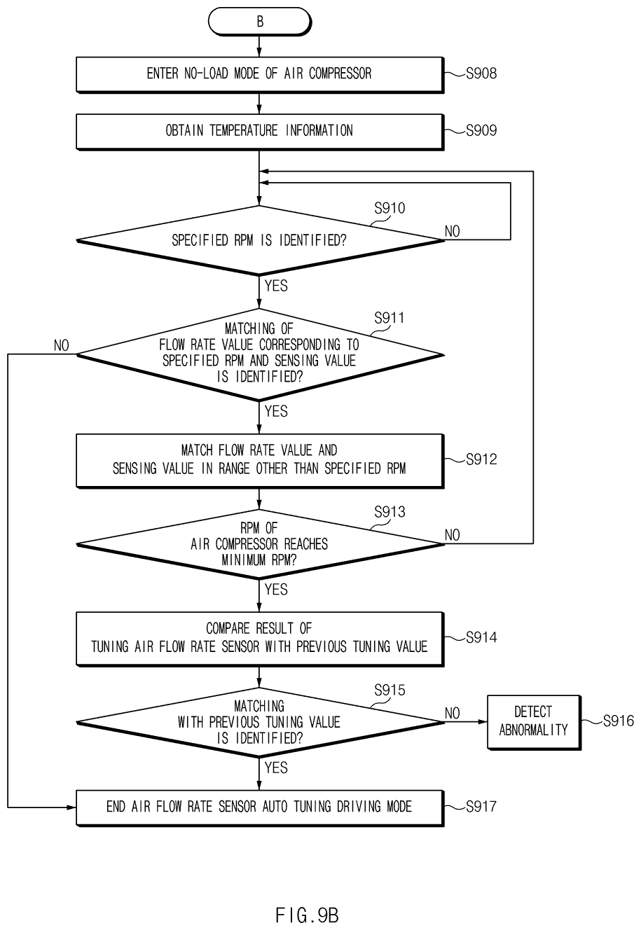

The vehicle control apparatus 100 according to an example may perform an operation of identifying the mapping data 125 to diagnose the state of the air intake system including the air compressor 160. The above-described operations performed by the vehicle control apparatus 100 will be described in more detail later with reference to FIG. 9.

As described above, the vehicle control apparatus 100 may control the flow rate of air supplied to the fuel cell stack 140 by using the air compressor 160, thereby controlling the output of a fuel cell system (or the fuel cell stack 140). In order to control the flow rate of air, the vehicle control apparatus 100 may identify the flow rate value representing the flow rate of air supplied to the fuel cell stack 140 by using the sensing value measured by the flow rate sensor 132 arranged adjacent to the inlet of the air intake system. If the air intake system is changed, the vehicle control apparatus 100 may perform an operation of tuning the sensing value measured by the flow rate sensor to be mapped to the flow rate value according to the characteristics of the air compressor 160 included in the newly changed air intake system or the shape of the air intake system. The vehicle control apparatus 100 may control the output of the fuel cell system more accurately by performing an operation of (e.g., causing) tuning the sensing value to be mapped to the flow rate value.

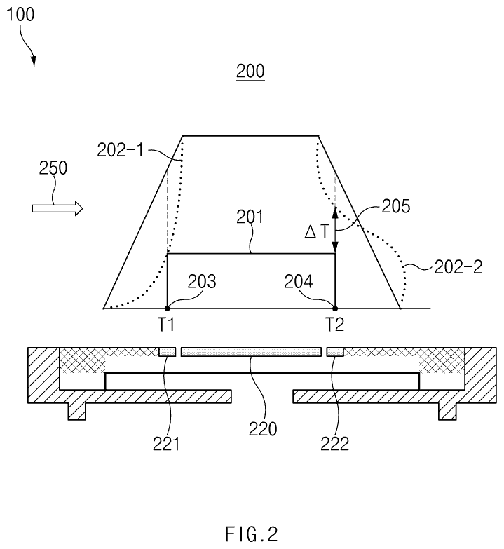

FIG. 2 is a diagram illustrating an example of an operation of identifying a flow rate value using a temperature sensor by a vehicle control apparatus according to an example of the present disclosure. The vehicle control apparatus 100 of FIG. 2 may be referred to as the vehicle control apparatus 100 of FIG. 1. Referring to FIG. 2, examples of graphs 201, 202-1 and 202-2 illustrating the difference in air temperature identified (e.g., measured, calculated, determined) by the vehicle control apparatus 100 according to the locations of temperature sensors 221 and 222 are shown.

The vehicle control apparatus 100 according to an example may use the first temperature sensor 221 and the second temperature sensor 222 to measure temperatures. The temperatures may be measured while and/or if air flows in a first direction 250. The first temperature sensor 221 and/or the second temperature sensor 222 may be included in the temperature sensor 131 of FIG. 1.

The temperature of the air flowing in the first direction 250 may be identified by using the first temperature sensor 221 and the second temperature sensor 222. For example, the graph 201 may represent the temperature of air flowing in the first direction 250 while the heater 220 is not driven/running.

Referring to the graph 201, because the air is not heated by the heater 220 while the heater 220 is not driven, the air temperature identified by the first temperature sensor 221 arranged at a first location 203 may have the same (e.g., substantially the same, within error/random variation, approximately the same) value as the air temperature identified by the second temperature sensor 222 arranged at a second location 204. Hereinafter, the “same” value may include a value that is the same within a specified error rate. However, the example is not limited thereto.

According to an example, while the heater 220 is driven/running (e.g., driven by the vehicle control apparatus 100), the vehicle control apparatus 100 may identify the temperature of air flowing in the first direction 250 by using the first temperature sensor 221 and the second temperature sensor 222. For example, the graph 202-1 may represent the air temperature identified by the vehicle control apparatus 100 using the first temperature sensor 221 while driving the heater 220. The graph 202-2 may represent the air temperature identified by the vehicle control apparatus 100 using the second temperature sensor 222 while driving the heater 220.

Referring to the graph 202-1, it may be understood that the temperature of air flowing in the first direction 250 increases as the air is closer to the heater 220.

Referring to the graph 202-2, it may be understood that the temperature of air flowing in the first direction 250 decreases as the distance from the heater 220 increases.

For example, because the air flowing in the first direction 250 is heated by the heater 220 while the heater 220 is driven/running, the air temperature identified by using the first temperature sensor 221 located at the first location 203 may be different from that identified by using the second temperature sensor 222 located at the second location 204.

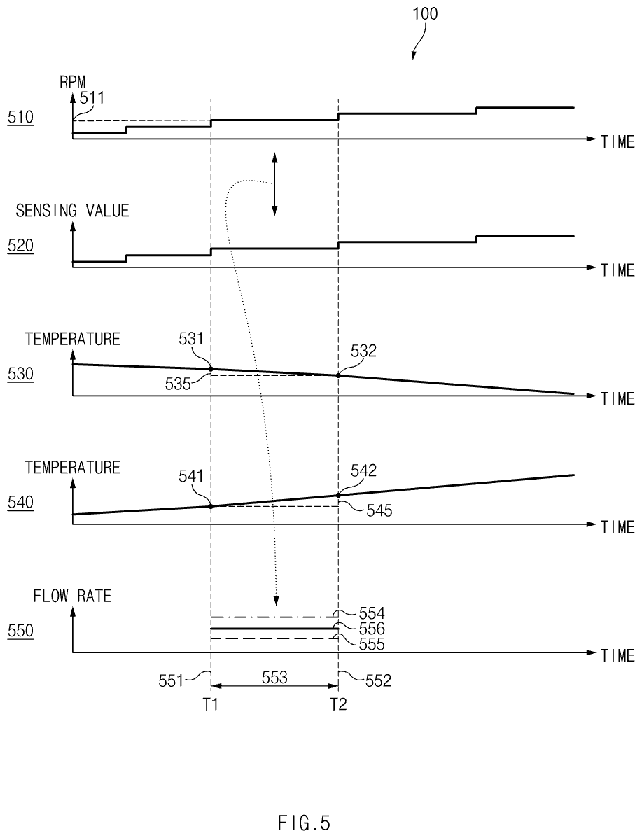

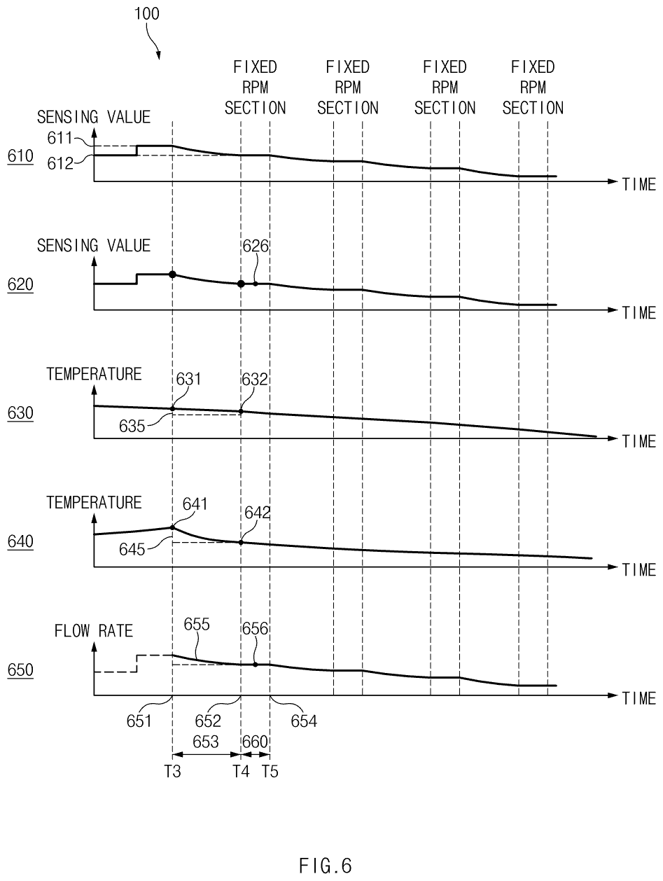

For example, the vehicle control apparatus 100 may identify a deviation 205 between the air temperature identified by using the first temperature sensor 221 and the air temperature identified by using the second temperature sensor 222 located at the second location 204. For example, the vehicle control apparatus 100 may use the deviation 205 to identify the flow rate of air flowing in the first direction 250. The operation of identifying the air flow rate using temperature by the vehicle control apparatus 100 will be described in more detail later with reference to FIGS. 5 and 6.

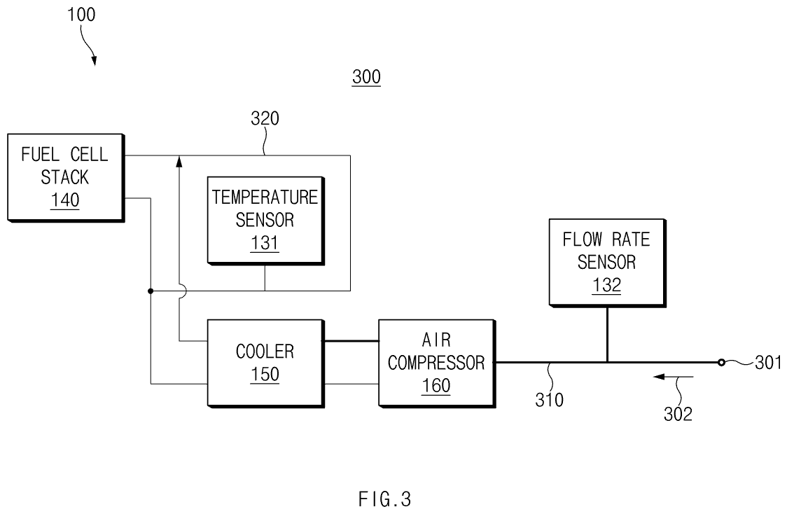

FIG. 3 is a block diagram illustrating an example of a hardware configuration included in a vehicle control apparatus according to an example of the present disclosure. The vehicle control apparatus 100 of FIG. 3 may be referred to as the vehicle control apparatus 100 of FIG. 1. For example, the vehicle control apparatus 100 may further include components not shown in FIG. 3. As an example, the vehicle control apparatus 100 may further include a system for managing the temperature of the air compressor 160. As an example, the vehicle control apparatus 100 may further include a temperature sensor for identifying an outside temperature.

Referring to FIG. 3, as an example 300, the flow rate sensor 132 may be arranged relatively adjacent to an outside 301 of the vehicle control apparatus 100 between the fuel cell stack 140 and the outside 301 of the vehicle control apparatus 100. The vehicle control apparatus 100 may use the flow rate sensor 132 to identify the flow rate of air flowing from the outside 301 of the vehicle control apparatus 100 through an air line 310 in a first direction 302. At least a portion of the air flowing through the air line 310 may be supplied to the fuel cell stack 140.

According to an example, the vehicle control apparatus 100 may supply coolant to the fuel cell stack 140 through (via) a coolant line 320 by using the cooler 150. The vehicle control apparatus 100 may identify the temperature of coolant flowing through the coolant line 320 by using the temperature sensor 131. The temperature of the coolant may be changed (may change) based on the temperature of the fuel cell stack, the amount of heat generated by driving the air compressor 160, the flow rate of air, and/or the outside temperature.

According to an example, the vehicle control apparatus 100 may further include a temperature sensor for identifying the temperature of the air compressor 160 (e.g., an external temperature of the air compressor 160, which determines the amount of heat generated by driving the air compressor 160). For example, the temperature of the air compressor 160 may be changed based on the internal temperature of the air compressor 160, the flow rate of air, and/or the outside temperature.

According to an example, the vehicle control apparatus 100 may identify/determine a flow rate value, indicating the flow rate of air, by using the temperature of the coolant and the temperature of the air compressor 160. The vehicle control apparatus 100 may compare the flow rate value with the sensing value representing the flow rate of air identified using the flow rate sensor 132. If there is a difference between the sensing value and the flow rate value, the vehicle control apparatus 100 may map the sensing value and the flow rate value. The vehicle control apparatus 100 may obtain mapping data that maps the identified sensing value and flow rate value according to time and/or revolutions per minute (RPM) of the air compressor.

As described above, the vehicle control apparatus 100 according to an example may reduce the cost of tuning the flow rate sensor by using mapping data. For example, the vehicle control apparatus 100 may configure the flow rate sensor to operate using the mapping data and/or cause the air compressor 160 to control air flow based on the mapping data (e.g., based on the air flow sensor 132 tuned based on the mapping data).

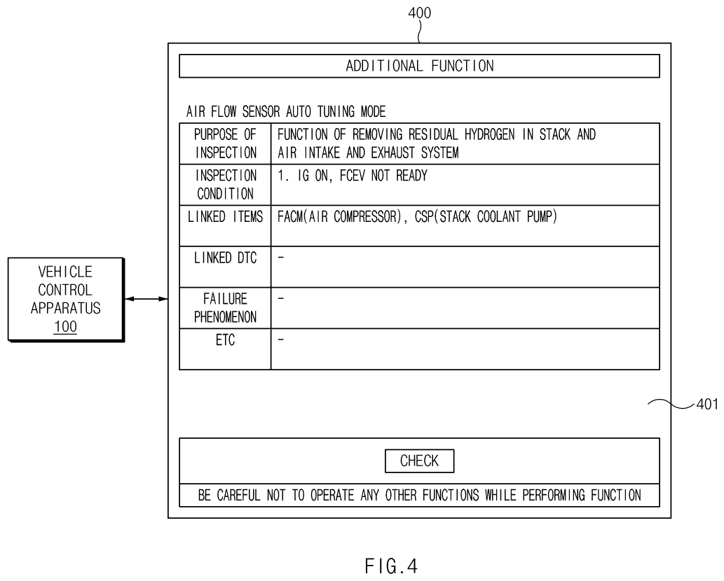

FIG. 4 is a diagram illustrating an example of a screen for a vehicle control apparatus according to an example of the present disclosure to initiate an operation of mapping a flow rate value and a sensing value. The vehicle control apparatus 100 of FIG. 4 may be referred to as the vehicle control apparatus 100 of FIG. 1.

Referring to FIG. 4, the vehicle control apparatus 100 according to an example may use an external electronic device 400 to initiate the performance of an operation of mapping a sensing value using a flow rate sensor and a flow rate value indicating the flow rate of air supplied to a fuel cell stack. For example, the external electronic device 400 may include a diagnostic device.

According to an example, the vehicle control apparatus 100 may receive an input for tuning a sensing value from the external electronic device 400 based on being connected to the external electronic device 400. For example, the vehicle control apparatus 100 may receive an input for tuning a sensing value from the external electronic device 400 after the air intake system is first coupled to the vehicle control apparatus 100. For example, the vehicle control apparatus 100 may receive an input indicating tuning of the sensing value according to a change of the air intake system from the external electronic device 400. For example, the vehicle control apparatus 100 may receive an input for checking a sensing value to diagnose a malfunction of the air intake system. However, the example is not limited thereto.

For example, the external electronic device 400 may use a screen 401 (e.g., an interface and/or display) to inform a user (e.g., output an indication) of a condition for tuning the sensing value and/or a hardware configuration (e.g., the air compressor 160 or the cooler 150 in FIG. 1) to be used for tuning the sensing value. The vehicle control apparatus 100 may use the external electronic device 400 to guide the user in taking necessary actions to tune the sensing value. For example, the vehicle control apparatus 100 may guide the user to conditions in which there is no change in flow rate due to external influences in order to tune the sensing value. The external influences may include driving wind as the vehicle drives. For example, the vehicle control apparatus 100 may guide the user to control the start (or ignition) of the vehicle. However, the example is not limited thereto.

According to an example, the vehicle control apparatus 100 may use the RPM of the air compressor to map the sensing value and the flow rate value. For example, the vehicle control apparatus 100 may map the flow rate value and the sensing value while driving an air compressor at a specified RPM. For example, the vehicle control apparatus 100 may map the flow rate value and the sensing value while temporarily stopping the operation of the air compressor at a no-load state.

Hereinafter, with reference to FIG. 5, the operation of mapping the flow rate value and the sensing value by the vehicle control apparatus 100 while the air compressor is driven at a specified RPM will be described later.

FIG. 5 is a diagram illustrating graphs of an example of an operation of mapping a sensing value and a flow rate value while a vehicle control apparatus according to an example of the present disclosure drives an air compressor at a specified RPM. The vehicle control apparatus 100 of FIG. 5 may be referenced to the vehicle control apparatus 100 of FIG. 1.

Referring to FIG. 5, a graph 510 may represent the RPM of the air compressor over time. A graph 520 may represent the sensing value identified through the flow rate sensor over time. A graph 530 may represent the temperature of the coolant (or the temperature of the fuel cell stack) over time. A graph 540 may represent the temperature of the air compressor over time. A graph 550 may represent the flow rate value of air supplied to the fuel cell stack.

Referring to the graph 510, the vehicle control apparatus 100 according to an example may drive an air compressor (e.g., the air compressor 160 of FIG. 1) at a specified RPM 511. For example, the vehicle control apparatus 100 may gradually increase the RPM of the air compressor from the minimum RPM of the air compressor. Based on identifying the RPM of the air compressor having the specified RPM 511, the vehicle control apparatus 100 may drive the air compressor by maintaining the RPM of the air compressor for a specified time 553. For example, the vehicle control apparatus 100 may identify one or more specified RPMs. For example, the vehicle control apparatus 100 may identify one or more specified RPMs according to preset data and/or performance of the air compressor.

For example, the vehicle control apparatus 100 may drive the air compressor at the first RPM and then drive the air compressor at the second RPM. The second RPM may have a higher value than the first RPM. For example, the specified time 553 may include a time which it takes to identify a first amount 535 of change in the temperature of the coolant and/or a second amount 545 of change in the temperature of the air compressor. However, the example is not limited thereto. For example, the specified time 553 may include a time during which the flow rate value is maintained without being affected by inertia, with the RPM fixed.

According to an example, while the vehicle control apparatus 100 drives an air compressor at the specified RPM 511 to supply air to the fuel cell stack from the outside of the vehicle control apparatus, the vehicle control apparatus 100 may use a flow rate sensor (e.g., the flow rate sensor 132 in FIG. 1) to identify a sensing value for measuring the flow rate of air corresponding to the specified RPM 511.

Referring to the graph 520, the vehicle control apparatus 100 according to an example may use a flow rate sensor (e.g., the flow rate sensor 132 in FIG. 1) to measure the flow rate of air flowing into the vehicle control apparatus 100 from the outside of the vehicle control apparatus 100 (e.g. the outside 301 of the vehicle control apparatus 100 in FIG. 3). Under conditions where there is no external influence (e.g., driving wind), the shape of the graph 520 may be referred to as the shape of the graph 510. In other words, the sensing value representing the flow rate of air identified using the flow rate sensor may be proportional to the RPM of the air compressor.

According to an example, the vehicle control apparatus 100 may use a temperature sensor to obtain the first amount 535 of change in the temperature of the coolant which flows using a cooler (e.g., the cooler 150 in FIG. 1) and the second amount 545 of change in the temperature of the air compressor during the specified time 533 during which the air compressor is driven at the specified RPM 511.

Referring to the graph 530, the vehicle control apparatus 100 according to an example may identify the temperature of the coolant by using a temperature sensor (e.g., the temperature sensor 131 in FIG. 1). For example, the vehicle control apparatus 100 may use a temperature sensor to identify a temperature 531 of the first coolant at a first time point 551. The vehicle control apparatus 100 may identify a temperature 532 of the second coolant at a second time point 552. The vehicle control apparatus 100 may use the temperature 531 of the first coolant and the temperature 532 of the second coolant to identify the first amount 535 of change in the temperature of the coolant during a specified time 553.

For example, the vehicle control apparatus 100 may obtain the first amount 535 of change by using the outside temperature, the temperature of the coolant identified by the temperature sensor (and/or the temperature of the fuel cell stack), the amount of heat generated based on the operation of the air compressor, the specified time, and/or a stack flow rate value 554 calculated based on the temperature of the coolant.

For example, if the air compressor is driven at the specified RPM 511, in order to identify the first amount 535 of change, the vehicle control apparatus 100 may identify the amount of heat generated by driving the air compressor. The identified heat generated by driving the air compressor may be accounted for in consideration of the change in temperature caused by heat emitted to the outside of the air compressor. For example, the amount of heat generated by driving the air compressor may be identified based on a two-dimensional matrix and based on pressure versus RPM. The vehicle control apparatus 100 may obtain the heat generation amount according to the specified RPM by using information about the heat generation amount indicating the heat generation amount based on the pressure according to the RPM. However, the example is not limited thereto.

Referring to the graph 540, the vehicle control apparatus 100 according to an example may identify the temperature of the air compressor. For example, the vehicle control apparatus 100 may identify a temperature 541 of the first air compressor at the first time point 551. The vehicle control apparatus 100 may identify a temperature 542 of the second air compressor at the second time point 552. The vehicle control apparatus 100 may use the temperature 541 of the first air compressor and the temperature 542 of the second air compressor to identify the second amount 545 of change in the temperature of the air compressor during the specified time 553.

For example, the vehicle control apparatus 100 may use a compressor flow rate value 555 calculated based on the outside temperature, the temperature of the air compressor (or the internal temperature of the air compressor), the specified time 553, and/or the temperature of the coolant to obtain the second amount 545 of change. For example, because the amount of heat generated by driving the air compressor is a parameter that affects the outside of the air compressor, the heat generation amount may not be used to identify the amount of change in the temperature of the air compressor. However, the example is not limited thereto.

Referring to the graph 550, the vehicle control apparatus 100 according to an example may use the first amount 535 of change in the temperature of the coolant and the second amount 545 of change in the temperature of the air compressor to obtain a flow rate value 556 representing the flow rate of air supplied to the fuel cell stack. For example, the vehicle control apparatus 100 may use the first amount 535 of change to obtain the flow rate value (e.g., the stack flow rate value 554) indicating the flow rate of air supplied to the fuel cell stack. For example, the vehicle control apparatus 100 may use the second amount 545 of change to obtain the flow rate value (e.g., the compressor flow rate value 555) indicating the flow rate of air supplied to the fuel cell stack. The flow rate value 556 may include an average value of the stack flow rate value 554 and the compressor flow rate value 555.

The vehicle control apparatus 100 according to an example may map, to the flow rate value 555, the sensing value (or the sensing value corresponding to the specified RPM) identified while driving the air compressor based on the specified RPM 511. For example, if a plurality of specified RPMs are set, the vehicle control apparatus 100 may repeatedly perform the above- described operation according to the plurality of specified RPMs, so that the sensing value corresponding to each of the plurality of specified RPMs is mapped to the flow rate value corresponding to each of the specified RPMs, thereby obtaining mapping data (e.g., the mapping data 125 in FIG. 1). For example, the specified RPM may be adjusted depending on the performance of the air supply system and/or the situation (and/or set value) that requires tuning.

For example, the set value may vary depending on whether the vehicle control apparatus 100 is included in a vehicle or a hydrogen generator. As an example, the set value may include a set value for a vehicle and/or a set value for power generation. As an example, if included in a vehicle, the vehicle control apparatus 100 may identify the RPM specified according to the vehicle setting value. If included in a generator (e.g., the hydrogen generator), the vehicle control apparatus 100 may identify the RPM specified according to the set value for power generation.

For example, the number of data sets representing RPM included in the vehicle setting value may be greater than the number of data sets representing RPM included in the power generation setting value. In other words, the vehicle control apparatus 100 may map the flow rate value and the sensing value more precisely if using the vehicle setting value than if using the power generation setting value.

The vehicle control apparatus 100 according to an example may identify the sensing value corresponding to the specified RPM 511 based on the fact that the air intake system including the air compressor is first coupled to the vehicle control apparatus 100. The vehicle control apparatus 100 may identify the sensing value corresponding to the specified RPM 511 based on identifying an input for diagnosing a malfunction of the air intake system. However, the example is not limited thereto.

As described above, the vehicle control apparatus 100 according to an example may tune the flow rate sensor of the air intake system by mapping the sensing value and the flow rate value corresponding to the specified RPM. The vehicle control apparatus 100 may more accurately measure the flow rate of air supplied to the fuel cell stack by using the sensing value identified using the tuned flow rate sensor.

Hereinafter, the operation of mapping the sensing value identified using the flow rate sensor and the flow rate value identified based on the temperature of the coolant and the temperature of the air compressor by the vehicle control apparatus 100 while driving the air compressor based on a no-load state will be described with reference to FIG. 6.

FIG. 6 is a diagram illustrating graphs of an example of an operation of mapping a sensing value and a flow rate value while a vehicle control apparatus according to an example of the present disclosure drives an air compressor based on a no-load state. The vehicle control apparatus 100 of FIG. 6 may be referred to as the vehicle control apparatus 100 of FIG. 1. A graph 610 may represent the RPM of the air compressor over time. A graph 620 may represent the sensing value identified through the flow rate sensor over time. A graph 630 may represent the temperature of the coolant (or the temperature of the fuel cell stack) over time. A graph 640 may represent the temperature of the air compressor over time. A graph 650 may represent the flow rate value of air supplied to the fuel cell stack.

The vehicle control apparatus 100 according to an example may increase the RPM of the air compressor up to a specified RPM 611. The specified RPM 611 may include the maximum RPM of the air compressor.

The vehicle control apparatus 100 according to an example may temporarily stop driving the air compressor after driving the air compressor at the specified RPM 611. A state in which the operation of the air compressor is temporarily stopped may be referred to as a no-load state.

The vehicle control apparatus 100 according to an example may temporarily stop driving the air compressor, so that it is possible to identify the sensing value for measuring the flow rate of air supplied to the fuel cell stack by using the flow rate sensor during a specified time 653 during which the RPM of the air compressor decreases from the specified RPM 611 to a specified RPM 612. For example, the specified RPM 611 may have a higher value than the specified RPM 612. If the specified RPM 612 is referred to as the first RPM, the specified RPM 611 may be referred to as the second RPM.

Referring to the graph 610, the specified RPM 612 may include the specified RPM 511 of FIG. 5.

Referring to the graph 620, in a state in which there is no external influence (e.g., driving wind), the sensing value identified using the flow rate sensor may be proportional to the RPM of the air compressor.

The vehicle control apparatus 100 according to an example may use a temperature sensor to obtain a third amount 635 of change in the temperature of the coolant and a fourth amount 645 of change in the temperature of the air compressor.

In an example, the vehicle control apparatus 100 may use a temperature sensor to identify a temperature 631 of the third coolant at a third time point 651. The vehicle control apparatus 100 may use a temperature sensor to identify a temperature 632 of the fourth coolant at a fourth time point 652. The vehicle control apparatus 100 may use the temperature 631 of the third coolant and/or the temperature 632 of the fourth coolant to identify the third amount 635 of change in the temperature of the coolant at a no load state of the air compressor.

For example, the vehicle control apparatus 100 may obtain the third amount 635 of change by using the temperature of the coolant identified using the temperature sensor (or the temperature of the fuel cell stack), the outside temperature, the specified time 653, and/or a stack flow rate value calculated based on the temperature of the coolant.

For example, the vehicle control apparatus 100 may use the third amount 635 of change to obtain a stack flow rate value indicating the flow rate of air supplied to the fuel cell stack. The stack flow rate value may be used to infer a flow rate value 655.

For example, the temperature of the coolant (or the temperature of the fuel cell stack) identified using the temperature sensor may include the temperature 631 of the third coolant and/or the temperature 632 of the fourth coolant.

For example, because the operation of the air compressor is temporarily stopped in a no load state of the air compressor, the vehicle control apparatus 100 may not use the heat generation amount caused by the operation of the air compressor to identify the third amount 635 of change.

In an example, the vehicle control apparatus 100 may identify a temperature 641 of the third air compressor at the third time point 651 by using a temperature sensor. The vehicle control apparatus 100 may identify a temperature 642 of the fourth air compressor at the fourth time point 652.

For example, in a no load state of the air compressor, the vehicle control apparatus 100 may use the temperature 641 of the third air compressor and/or the temperature 642 of the fourth air compressor to identify the fourth amount 645 of change in the temperature of the air compressor.

For example, the vehicle control apparatus 100 may use the temperature of the air compressor, the outside temperature, the specified time 653, and/or the compressor flow rate value based on the temperature of the air compressor to identify the fourth amount 645 of change.

For example, the vehicle control apparatus 100 may use the fourth amount 645 of change to obtain the compressor flow rate value indicating the flow rate of air supplied to the fuel cell stack. The compressor flow rate value may be used to infer the flow rate value 655.

According to an example, the vehicle control apparatus 100 may obtain the flow rate value 655 indicating the flow rate of air to be supplied to the fuel cell stack based on the third amount 635 of change and the fourth amount 645 of change during the specified time 653.

For example, the flow rate value 655 may include an average value of the stack flow rate value corresponding to the third amount 635 of change and the compressor flow rate value corresponding to the fourth amount 645 of change. However, the example is not limited thereto.

According to an example, the vehicle control apparatus 100 may map the sensing value identified using the flow rate sensor during the specified time 653 in a no load state of the air compressor to the flow rate value 655. The vehicle control apparatus 100 may obtain mapping data by using the sensing value and the flow rate value 655.

According to an example, the vehicle control apparatus 100 may map the sensing value and the flow rate value in a no load state of the air compressor, and then perform a review of the sensing value and the flow rate value mapped while driving the air compressor at the specified RPM.

According to an example, the vehicle control apparatus 100 may identify the RPM of the air compressor reduced to the specified RPM 612 after the specified time 653. Based on identifying the RPM of the air compressor corresponding to the specified RPM 612, the vehicle control apparatus 100 may initiate driving the air compressor based on the specified RPM.

According to an example, the vehicle control apparatus 100 may determine whether a sensing value 626 is mapped to a flow rate value 656 while driving the air compressor at the specified RPM 612.

For example, the sensing value 626 and the flow rate value 656 may be included in the mapping data representing the sensing value and the flow rate value 556 mapped in FIG. 5.

For example, if the identified sensing value 626 is mapped to the flow rate value 656 during a specified time 660 at the specified RPM 612, the vehicle control apparatus 100 may identify that the mapping data on the sensing value and the flow rate value 556 mapped in FIG. 5 is accurate.

For example, if the identified sensing value 626 is not mapped to the flow rate value 656 during the specified time 660 at the specified RPM 612, the vehicle control apparatus 100 may identify that an error occurs in the mapping data on the sensing value and the flow rate value 556 mapped in FIG. 5.

For example, the vehicle control apparatus 100 may temporarily stop the operation of tuning the flow rate sensor based on identifying an error in the mapping data. For example, the vehicle control apparatus 100 may perform the operation of mapping the sensing value and the flow rate value while driving the air compressor at a specified RPM (e.g., the specified RPM 511 in FIG. 5) based on identifying an error in the mapping data.

For example, the vehicle control apparatus 100 may identify an error in the mapping data obtained in FIG. 5 by repeatedly performing the above-described operation for each specified RPM (for each RPM fixed section in FIG. 6). However, the example is not limited thereto.

According to an example, if the sensing value is identified using the flow rate sensor independently of the RPM of the air compressor by using the mapping data obtained while driving the air compressor at the specified RPM and the mapping data obtained in the no load state of the air compressor, the vehicle control apparatus 100 may infer the flow rate value representing the flow rate of air to be supplied to the fuel cell stack.

According to an example, the vehicle control apparatus 100 may diagnose the state of the air intake compressor by using the mapping data.

According to an example, if diagnosing the state of the air intake system including the air compressor, the vehicle control apparatus 100 may identify another sensing value corresponding to the specified RPM.

According to an example, the vehicle control apparatus 100 may obtain another flow rate value representing the flow rate of the air supplied to the fuel cell stack by using the change in temperature of the coolant and the change in temperature of the air compressor.

For example, the vehicle control apparatus 100 may obtain different mapping data by mapping different sensing values to different flow rate values.

According to an example, the vehicle control apparatus 100 may compare another flow rate value corresponding to other mapping data with the flow rate value corresponding to the mapping data, based on mapping the sensing value to the flow rate value.

For example, the vehicle control apparatus 100 may determine whether the air intake system is broken using the stored mapping data and other mapping data obtained after storing the mapping data.

According to an example, if the flow rate value is equal to another flow rate value, the vehicle control apparatus 100 may identify (or diagnose) the state of the air intake system as a normal state.

According to an example, the vehicle control apparatus 100 may identify the state of the air intake system as a normal state if the difference between the flow rate value and another flow rate value is within a preset range.

According to an example, if the flow rate value is different from another flow rate value, the vehicle control apparatus 100 may identify the state of the air intake system as an abnormal state.

According to an example, if the difference between the flow rate value and another flow rate value is outside the preset range, the vehicle control apparatus 100 may identify the state of the air intake system as an abnormal state.

As described above, according to an example, the vehicle control apparatus 100 may map the sensing value and the flow rate value in a no load state of the air compressor. If the sensing value and the flow rate value are mapped, and the sensing value is identified using the flow rate sensor independently of the shape of the air intake system, the RPM of the air compressor, and/or the location of the flow rate sensor, the vehicle control apparatus 100 may infer the flow rate value representing the flow rate of air to be supplied to the fuel cell stack.

According to an example, the vehicle control apparatus 100 may diagnose the state of the air intake system including the air compressor by using the mapping data. The vehicle control apparatus 100 may provide the user with the state of the air intake system diagnosed by using the mapping data. The vehicle control apparatus 100 may more accurately manage the flow rate to be supplied to the fuel cell stack by performing the operation of mapping the flow rate value and the sensing value. In addition, the vehicle control apparatus 100 may provide the state of the air intake system to the user by performing the operation of mapping the flow rate value and the sensing value.

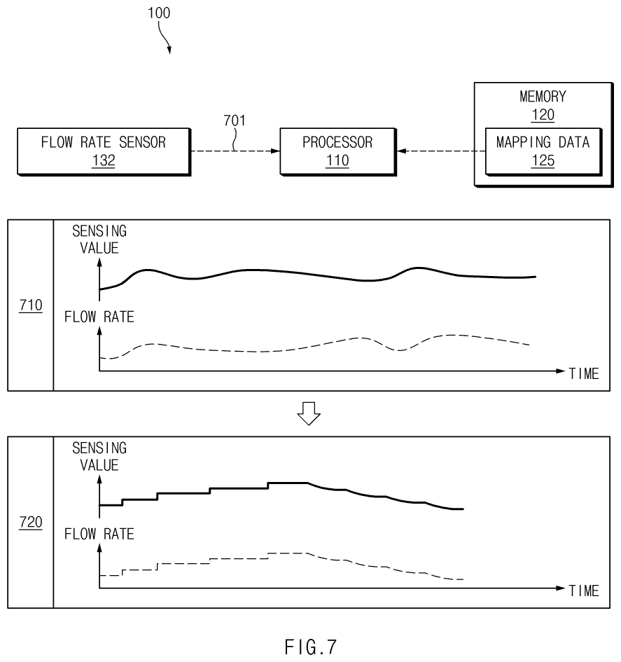

FIG. 7 is a diagram illustrating an example of a graph showing a result of mapping a sensing value and a flow rate value by a vehicle control apparatus according to an example of the present disclosure. The vehicle control apparatus 100 of FIG. 7 may include the vehicle control apparatus 100 of FIG. 1.

According to an example, the processor 110 of the vehicle control apparatus 100 may obtain a signal 701 representing the sensing value identified through the flow rate sensor 132 while supplying air from the outside of the vehicle control apparatus 100 to the fuel cell stack by driving the air compressor. The signal 701 may include an electrical signal. The electrical signal may be transmitted or received based on pulse width modulation (PWM) and/or single edge nibble transmission (SENT) communication.

According to an example, the processor 110 of the vehicle control apparatus 100 may identify the flow rate value corresponding to the sensing value if the sensing value corresponding to the signal 701 is identified by using the mapping data 125 obtained by performing the operations of FIGS. 5 and 6.

For example, if there is no mapping data, a graph 710 may include a graph representing the sensing value identified by the vehicle control apparatus 100 and a graph representing the flow rate value inferred by the vehicle control apparatus 100.

For example, if there is mapping data, a graph 720 may include a graph representing the sensing value identified by the vehicle control apparatus 100 and a graph representing the flow rate value inferred by the vehicle control apparatus 100.

Referring to the graph 710 and the graph 720, if there is mapping data, the vehicle control apparatus 100 may determine the flow rate of air to be supplied to the fuel cell stack relatively and more accurately than the flow rate of air to be identified if there is no mapping data.

As described above, according to an example, the vehicle control apparatus 100 may mange a fuel cell system independently of the shape and/or change of the air intake system by mapping the sensing value and the flow rate value using the mapping data 125.

FIGS. 8A and 8B are flowcharts illustrating an example of an operation of a vehicle control apparatus according to an example of the present disclosure. Hereinafter, it is assumed that the vehicle control apparatus 100 of FIG. 1 performs the processes of FIGS. 8A and 8B. In addition, it may be understood in the description of FIGS. 8A and 8B that operations described as being performed by an apparatus may be controlled by the processor 110 of the vehicle control apparatus 100. Each of the operations in FIGS. 8A and 8B may be performed sequentially, but are not necessarily performed sequentially. For example, the order of each operation may be changed, and at least two operations may be performed in parallel.

Referring to FIG. 8A, in operation S801, a vehicle control apparatus according to an example may enter an air flow rate sensor auto tuning driving mode. The vehicle control apparatus may enter the air flow rate sensor auto tuning driving mode by using an external electronic device (e.g., the external electronic device 400 of FIG. 4). For example, the vehicle control apparatus may perform operation S801 based on the fact the vehicle control apparatus is first coupled to the air intake system. However, the example is not limited thereto.

Referring to FIG. 8A, in operation S802, the vehicle control apparatus according to an example may identify whether a condition without external influence is secured. If the vehicle control apparatus identifies an external influence (e.g. driving wind) (operation S802—No), the vehicle control apparatus may wait until a condition without external influence is secured. However, the example is not limited thereto.

Referring to FIG. 8A, if a condition without external influence is secured (operation S802-Yes), in operation S803, the vehicle control apparatus according to an example may enter a fixed mode for each RPM section of the air compressor.

For example, the fixed mode for each RPM section of the air compressor may include a mode for identifying the internal pressure or temperature of the vehicle control apparatus while driving the air compressor at the specified RPM.

Referring to FIG. 8A, in operation S804, the vehicle control apparatus according to an example may obtain pressure and temperature information.

For example, the vehicle control apparatus may use an air cut off valve (ACV) to generate an air line (e.g., a bypass line) through which air to be provided to the fuel cell stack moves. However, the example is not limited thereto.

For example, the vehicle control apparatus may use an air pressure control valve (APC) to adjust the amount of air to be provided to the fuel cell stack. However, the example is not limited thereto.

For example, the vehicle control apparatus may use pressure to identify the amount of heat generated by driving the air compressor. The vehicle control apparatus may use the temperature sensor to identify the temperature of the air compressor and/or the temperature of the coolant.

For example, the vehicle control apparatus 100 may identify the amount (e.g., the first amount 535 of change in FIG. 5) of change in the temperature of the coolant and/or the amount (e.g., the second amount 545 of change in FIG. 5) of change in the temperature of the air compressor during the time (e.g., the specified time 553 in FIG. 5) during which the air compressor is driven at the specified RPM.

For example, the vehicle control apparatus 100 may use the amount of change in the temperature of the coolant and the amount of change in the temperature of the air compressor to obtain the flow rate value (e.g., the flow rate value 556 in FIG. 5) indicating the flow rate of air to be supplied to the fuel cell stack.

Referring to FIG. 8A, in operation S805, the vehicle control apparatus according to an example may determine whether the sensing value of the flow rate sensor is maintained at a constant (or specified) level. For example, the vehicle control apparatus may determine whether the sensing value is maintained while the RPM of the air compressor is maintained at a specified RPM.

For example, if the sensing value of the flow rate sensor is not maintained at a certain level (operation S805—No), it may be possible to temporarily refrain from performing operation S806 until the sensing value of the flow rate sensor is maintained at a constant level. However, the example is not limited thereto.

Referring to FIG. 8A, if the sensing value of the flow rate sensor is maintained at a constant level (operation S805—Yes), the vehicle control apparatus according to an example may match the flow rate value with the sensing value in operation S806.

For example, the vehicle control apparatus may store the matched flow rate value and sensing value in a memory based on the type of mapping data.

Referring to FIG. 8A, the vehicle control apparatus according to an example may identify whether the RPM of the air compressor reaches the maximum RPM in operation S807.

For example, if the RPM of the air compressor is not at maximum (operation S807—No), the vehicle control apparatus according to an example may increase the RPM of the air compressor until the RPM of the air compressor reaches the maximum RPM and may repeatedly perform operations S805 to S807. However, the example is not limited thereto.

For example, the vehicle control apparatus may go to ‘A’ if the RPM of the air compressor reaches the maximum RPM (operation S807—Yes). For example, after entering ‘A’, the vehicle control apparatus may terminate the air flow rate sensor auto tuning driving mode, but the example is not limited thereto.

Referring to FIG. 8B, the vehicle control apparatus that has entered ‘A’ may enter the no-load mode (or no-load state) of the air compressor in operation S808.

For example, the vehicle control apparatus may reduce the RPM of the air compressor by temporarily stopping the operation of the air compressor that has reached the maximum RPM. In operation S809, the vehicle control apparatus may obtain temperature information while reducing the RPM of the air compressor.

For example, the temperature information may include the temperature of the coolant and/or the temperature of the air compressor. For example, by temporarily stopping the operation of the air compressor, the vehicle control apparatus may not obtain pressure information because the amount of heat generated by driving the air compressor is not used. However, the example is not limited thereto.

Referring to FIG. 8B, in operation S810, the vehicle control apparatus according to an example may determine whether the specified RPM of the air compressor is identified. The specified RPM may include the specified RPM 511 in FIG. 5, and/or the specified RPM 612 in FIG. 6. If the specified RPM is not identified (operation S810—No), the vehicle control apparatus according to an example may wait until the specified RPM is identified. However, the example is not limited thereto.

Referring to FIG. 8B, if the specified RPM of the air compressor is identified (operation S810—Yes), it is possible in operation S811 to determine whether the flow rate value corresponding to the specified RPM matches the sensing value.

For example, operation S811 may include an operation in which the vehicle control apparatus determines whether the flow rate value and the sensing value matched in operation S806 are accurate.

For example, if the flow rate value corresponding to the specified RPM does not match the sensing value (operation S811—No), the vehicle control apparatus may perform operation S815.

For example, if the flow rate value corresponding to the specified RPM and the sensing value do not match (operation S811—No), the air flow rate sensor auto tuning driving mode may be terminated by identifying the failure of the air flow rate sensor auto tuning driving mode. However, the example is not limited thereto.

Referring to FIG. 8B, if the flow rate value corresponding to the specified RPM matches the sensing value (operation S811), the flow rate value and the sensing value may be matched in a range other than the specified RPM in operation S812. The range other than the specified RPM may include a range in which the RPM of the air compressor decreases from the maximum RPM of the air compressor to the specified RPM. The range other than the specified RPM may include the RPM section of the air compressor corresponding to the specified time 653 in FIG. 6. However, the example is not limited thereto.

Referring to FIG. 8B, it is possible in operation S813 to determine whether the RPM of the air compressor reaches the minimum RPM.

For example, if the RPM of the air compressor is not the minimum RPM (operation S813—No), the vehicle control apparatus according to an example may perform operations S810 through operation S813 until the RPM of the air compressor corresponds to the minimum RPM. However, the example is not limited thereto.

Referring to FIG. 8B, if the RPM of the air compressor reaches the minimum RPM (operation S813—Yes), the matched flow rate value and sensing value may be stored in the memory in operation S814. According to an example, the vehicle control apparatus may store the flow rate values and the sensing values based on the mapping data. The operation of storing the flow rate value and the sensing value may include the operation of storing the mapping data in a non-volatile memory.

Referring to FIG. 8B, in operation S815, the vehicle control apparatus according to an example may end the air flow rate sensor auto tuning driving mode.

For example, the vehicle control apparatus may measure the sensing value representing the flow rate of air by using the flow rate sensor while providing air to the fuel cell stack from the outside of the vehicle control apparatus based on the RPM of the air compressor. For example, the vehicle control apparatus may use the sensing value measured using the mapping data to more accurately identify the flow rate of air provided to the fuel cell stack.

FIGS. 9A and 9B are flowcharts illustrating an example of an operation of a vehicle control apparatus according to an example of the present disclosure. Hereinafter, it is assumed that the vehicle control apparatus 100 of FIG. 1 performs the processes of FIGS. 9A and 9B. In addition, it may be understood in the description of FIGS. 9A and 9B that operations described as being performed by an apparatus may be controlled by the processor 110 of the vehicle control apparatus 100. Each of the operations in FIGS. 9A and 9B may be performed sequentially, but are not necessarily performed sequentially. For example, the order of each operation may be changed, and at least two operations may be performed in parallel. At least one of the operations in FIGS. 9A and 9B may be related to at least one of the operations in FIGS. 8A and 8B.

Referring to FIG. 9A, in operation S901, a vehicle control apparatus according to an example may enter an air flow rate sensor auto tuning driving mode. For example, the vehicle control apparatus may perform operation S901 of diagnosing a malfunction of the air intake system. The vehicle control apparatus may perform operation S901 based on receiving an input for diagnosing a malfunction of the air intake system using an external electronic device (e.g., the external electronic device 400 in FIG. 4).

Referring to FIG. 9A, in operation S902, the vehicle control apparatus according to an example may identify whether a condition without external influence is secured. Operation S902 may be referenced to operation S802 of FIG. 8A.

Referring to FIG. 9A, if a condition without external influence is secured (operation S902—Yes), in operation S903, the vehicle control apparatus according to an example may enter a fixed mode for each RPM section of the air compressor. Operation S903 may be referenced to operation S803 of FIG. 8A.

Referring to FIG. 9A, in operation S904, the vehicle control apparatus according to an example may obtain pressure and temperature information. Operation S904 may be referenced to operation S804 of FIG. 8A.

Referring to FIG. 9A, in operation S905, the vehicle control apparatus according to an example may determine whether the sensing value of the flow rate sensor is maintained at a constant (or specified) level. Operation S905 may be referenced to operation S805 of FIG. 8A.

Referring to FIG. 9A, according to an example, if the sensing value of the flow rate sensor is maintained at a constant level (operation S905—Yes), the vehicle control apparatus may match the flow rate value with the sensing value in operation S906. Operation S906 may be referenced to operation S806 of FIG. 8A.

Referring to FIG. 9A, the vehicle control apparatus according to an example may identify whether the RPM of the air compressor reaches the maximum RPM in operation S907. Operation S907 may be referenced to operation S807 of FIG. 8A.

For example, the vehicle control apparatus may go to ‘B’ if the RPM of the air compressor reaches the maximum RPM (operation S907—Yes).

Referring to FIG. 9B, the vehicle control apparatus that has entered ‘B’ may enter the no-load mode (or no-load state) of the air compressor in operation S908. Operation S908 may be referenced to operation S808 of FIG. 8B.

In operation S909, the vehicle control apparatus may obtain temperature information while reducing the RPM of the air compressor. Operation S909 may be referenced to operation S809 in FIG. 8B.

Referring to FIG. 9B, in operation S910, the vehicle control apparatus according to an example may determine whether the specified RPM of the air compressor is identified. Operation S910 may be referenced to operation S810 of FIG. 8B.

Referring to FIG. 9B, if the specified RPM of the air compressor is identified (operation S910—Yes), it is possible in operation S911 to determine whether the flow rate value corresponding to the specified RPM matches the sensing value. Operation S911 may be referenced to operation S811 of FIG. 8B.

For example, if the flow rate value corresponding to the specified RPM does not match the sensing value (operation S911—No), the vehicle control apparatus may perform operation S917. For example, if the flow rate value corresponding to the specified RPM and the sensing value do not match (operation S911—No), the air flow rate sensor auto tuning driving mode may be terminated by identifying the failure of the air flow rate sensor auto tuning driving mode. However, the example is not limited thereto.

Referring to FIG. 9B, if the flow rate value corresponding to the specified RPM matches the sensing value (operation S911), the flow rate value and the sensing value may be matched in a range other than the specified RPM in operation S912. Operation S912 may be referenced to operation S812 of FIG. 8B.

Referring to FIG. 9B, it is possible in operation S913 to determine whether the RPM of the air compressor reaches the minimum RPM. Operation S913 may be referenced to operation S813 in FIG. 8B.

Referring to FIG. 9B, if the RPM of the air compressor reaches the minimum RPM (operation S913—Yes), in operation S914, as a result of tuning the air flow rate sensor, the matched flow rate value and sensing value may be compared with the previous tuning values.

For example, the vehicle control apparatus 100 may perform operation S914 by using the mapping data stored after performing operation S814 of FIG. 8B.

Referring to FIG. 9B, in operation S915, the vehicle control apparatus according to an example may determine whether the previous tuning values (e.g., the mapping data stored after performing operation S814 of FIG. 8B) match the tuning values representing the flow rate value and the sensing value matched after performing operation S912.

For example, if the tuning values representing the flow rate value and sensing value matched after performing operation S912 do not match the previous tuning values (operation S915—No), in operation S916, it is possible to detect an abnormality (or failure) of the air intake system.

For example, the vehicle control apparatus may diagnose the state of the air intake system as a failure state. The vehicle control apparatus may provide the state of the air intake system to the user.

For example, the vehicle control apparatus may provide the state of the air intake system to the user by using an external electronic device.

For example, the external electronic device may inform the user of the state of the air intake system by displaying a screen indicating the state of the air intake system on the display.

Referring to FIG. 9B, if the tuning values representing the flow rate value and sensing value matched after performing operation S912 match the previous tuning values (operation S915—No), in operation S917, the vehicle control apparatus according to an example may terminate the air flow rate sensor auto tuning driving mode.

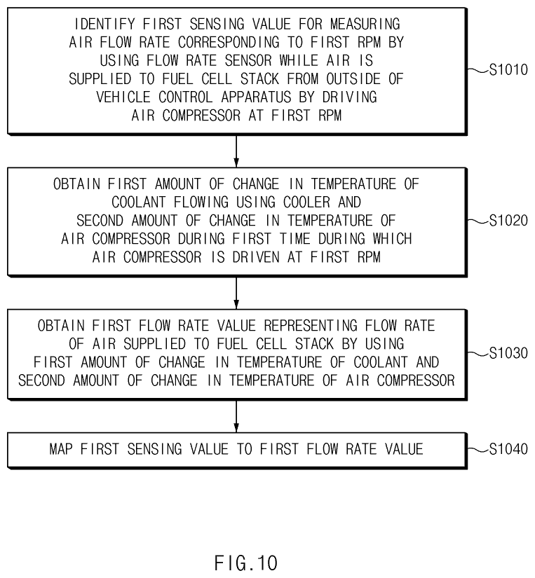

FIG. 10 is a flowchart illustrating an example of a vehicle control method according to an example of the present disclosure. Hereinafter, it is assumed that the vehicle control apparatus 100 of FIG. 1 performs the process of FIG. 10. In addition, it may be understood in the description of FIG. 10 that operations described as being performed by an apparatus may be controlled by the processor 110 of the vehicle control apparatus 100. Each of the operations in FIG. 10 may be performed sequentially, but are not necessarily performed sequentially. For example, the order of each operation may be changed, and at least two operations may be performed in parallel.

Referring to FIG. 10, a vehicle control method according to an example may include operation S1010 of identifying a first sensing value for measuring a flow rate of air corresponding to a first RPM by using a flow rate sensor (e.g., the flow rate sensor 132 of FIG. 1) while air is supplied to a fuel cell stack (e.g., the fuel cell stack 140 in FIG. 1) from an outside of the vehicle control apparatus (e.g., the outside 301 of the vehicle control apparatus in FIG. 3) by driving an air compressor (e.g., the air compressor 160 in FIG. 1) at the first RPM (e.g., the specified RPM 511 in FIG. 5).

In an example, the first sensing value may be included in the graph 520 in FIG. 5. The first sensing value may be changed based on the first RPM. For example, the first sensing value may be maintained while the first RPM is maintained.

Referring to FIG. 10, the vehicle control method according to an example may include operation S1320 of obtaining a first amount (e.g., the first amount 635 of change in FIG. 5) of change in the temperature of a coolant flowing using a cooler (e.g., the cooler 150 in FIG. 1) and a second amount (e.g., the second amount 645 of change in FIG. 5) of change in the temperature of the air compressor during a first time (e.g., the specified time 553 in FIG. 5) during which the air compressor is driven at the first RPM.

Referring to FIG. 10, the vehicle control method according to an example may include operation S1030 of obtaining a first flow rate value (e.g., the flow rate value 556 in FIG. 5) representing a flow rate of air supplied to a fuel cell stack by using the first amount of change in the temperature of the coolant and the second amount of change in the temperature of the air compressor.

For example, the vehicle control method may include an operation of obtaining a stack flow rate value (e.g., the stack flow rate value 554 in FIG. 5) that represents the flow rate of air supplied to the fuel cell stack by using the first amount of change.

For example, the vehicle control method includes an operation of obtaining a compressor flow rate value (e.g., the compressor flow rate value 555 in FIG. 5) that represents the flow rate of air supplied to the fuel cell stack by using the second amount of change.

For example, the vehicle control method may include an operation of obtaining a flow rate value including an average value of the stack flow rate value and the compressor flow rate value.

Referring to FIG. 10, the vehicle control method according to an example may include an operation S1040 of mapping the first sensing value to the first flow rate value. The vehicle control method may include an operation of obtaining mapping data by mapping the first sensing value to the first flow rate value.

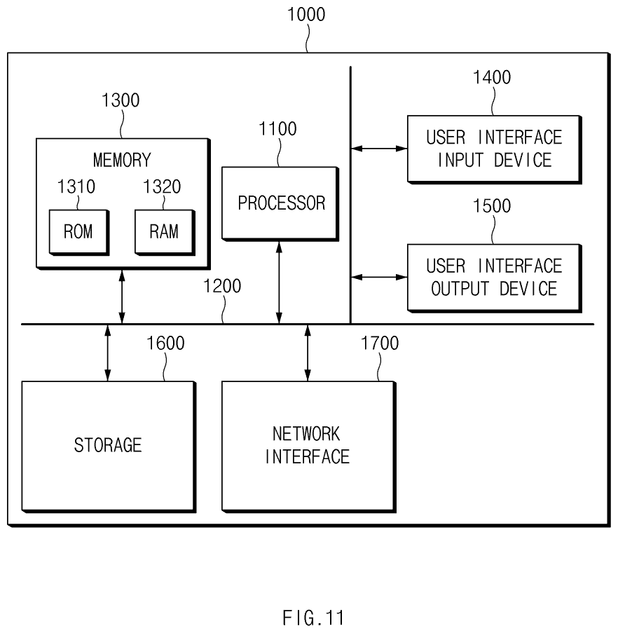

FIG. 11 is a block diagram illustrating a computing system related to a vehicle control apparatus or a method of controlling a vehicle according to an example of the present disclosure.

Referring to FIG. 11, The computing system 1000 may include at least one processor 1100, a memory 1300, a user interface input device 1400, a user interface output device 1500, storage 1600, and a network interface 1700 connected through a system bus 1200.

The processor 1100 may be a central processing device (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Thus, the operations of the method or the algorithm described in connection with the examples disclosed herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a removable disk, and a CD-ROM.

The exemplary storage medium may be coupled to the processor 1100, and the processor 1100 may read information out of the storage medium and may record information in the storage medium. Alternatively, the storage medium may be integrated with the processor 1100. The processor 1100 and the storage medium may reside in an application specific integrated circuit (ASIC). The ASIC may reside within a user terminal. In another case, the processor 1100 and the storage medium may reside in the user terminal as separate components.

The present disclosure has been made to solve the above-mentioned problems, and others.

An aspect of the present disclosure provides a vehicle control apparatus capable of identifying a flow rate of air provided to a fuel cell stack, and a method thereof.

Another aspect of the present disclosure provides a vehicle control apparatus capable of tuning a sensing value identified using a flow rate sensor into a flow rate value indicating a flow rate of air, and a method thereof.

Still another aspect of the present disclosure provides a vehicle control apparatus capable of diagnosing the status of an air intake system for supplying air to a fuel cell stack, and a method thereof.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a vehicle control apparatus includes a processor, a memory, a fuel cell stack, an air compressor, a temperature sensor, and a flow rate sensor. The processor may identify a first sensing value for measuring a flow rate of air corresponding to a first revolutions per minute (RPM) by using the flow rate sensor while the air is supplied to the fuel cell stack from an outside of the vehicle control apparatus by driving the air compressor based on the first RPM, obtain a first amount of change in a temperature of a coolant flowing using a cooler and a second amount of change in a temperature of the air compressor by using the temperature sensor during a first time during which the air compressor is driven based on the first RPM, obtain a first flow rate value representing the flow rate of the air supplied to the fuel cell stack by using the first amount of change in the temperature of the coolant and the second amount of change in the temperature of the air compressor, and map the first sensing value to the first flow rate value.

For example, the processor may temporarily stop driving of the air compressor after driving the air compressor based on a second RPM higher than the first RPM, identify a second sensing value for measuring the flow rate of the air supplied to the fuel cell stack by using the flow rate sensor during a second time during which an RPM of the air compressor decreases from the second RPM to the first RPM by temporarily stopping driving of the air compressor, obtain a third amount of change in the temperature of the coolant and a fourth amount of change in the temperature of the air compressor by using the temperature sensor, obtain a second flow rate value representing the flow rate of the air to be supplied to the fuel cell stack based on the third amount of change and the fourth amount of change during the second time, and map the second sensing value to the second flow rate value.

For example, the processor may start to drive the air compressor based on the first RPM after the second time, and check whether the first sensing value is mapped to the first flow rate value while driving the air compressor based on the first RPM.

For example, the processor may obtain the third amount of change by using at least one of an outside temperature, the temperature of the coolant, the second time, or a combination thereof, and obtain the fourth amount of change by using at least one of the outside temperature, the temperature of the air compressor, the second time, or a combination thereof.

For example, the processor may obtain a third flow rate value representing the flow rate of the air supplied to the fuel cell stack by using the third amount of change, obtain a fourth flow rate value representing the flow rate of the air supplied to the fuel cell stack by using the fourth amount of change, and obtain the second flow rate value including an average value of the third flow rate value and the fourth flow rate value.

For example, the processor may obtain the first amount of change by using at least one of an outside temperature, the temperature of the coolant, a heat generation amount based on driving of the air compressor, the first time, or a combination thereof, and obtain the second amount of change by using at least one of the outside temperature, the temperature of the air compressor, the first time, or a combination thereof.

For example, the processor may obtain a fifth flow rate value representing the flow rate of the air supplied to the fuel cell stack by using the first amount of change, obtain a sixth flow rate value representing the flow rate of the air supplied to the fuel cell stack by using the second amount of change, and obtain the first flow rate value including an average value of the fifth flow rate value and the sixth flow rate value.

For example, the processor may identify the first sensing value for measuring the flow rate of the air by using the flow rate sensor adjacent to an outside of the vehicle control apparatus of the outside of the vehicle control apparatus and the fuel cell stack.

For example, the processor may identify the first sensing value based on that an air intake system including the air compressor is first coupled to the vehicle control apparatus.

For example, the processor may identify the first sensing value corresponding to the first RPM if diagnosing a state of the air intake system, obtain a seventh flow rate value representing the flow rate of the air supplied to the fuel cell stack by using the first amount of change and the second amount of change, compare the first flow rate value and the seventh flow rate value based on that the first sensing value is mapped to the seventh flow rate value, identify the state of the air intake system as a normal state if the first flow rate value is equal to the seventh flow rate value or a difference between the first flow rate value and the seventh flow rate value is within a preset range, and identify the state of the air intake system as a failure state if the first flow rate value is different from the seventh flow rate value or the difference between the first flow rate value and the seventh flow rate value is outside the preset range.

According to another aspect of the present disclosure, a method of controlling a vehicle performed by a vehicle control apparatus includes identifying a first sensing value for measuring a flow rate of air corresponding to a first revolutions per minute (RPM) by using a flow rate sensor while the air is supplied to a fuel cell stack from an outside of the vehicle control apparatus by driving an air compressor based on the first RPM, obtaining a first amount of change in a temperature of a coolant flowing using a cooler and a second amount of change in a temperature of the air compressor by using a temperature sensor during a first time during which the air compressor is driven based on the first RPM, obtaining a first flow rate value representing the flow rate of the air supplied to the fuel cell stack by using the first amount of change in the temperature of the coolant and the second amount of change in the temperature of the air compressor, and mapping the first sensing value to the first flow rate value.

For example, the method may further include temporarily stopping driving of the air compressor after driving the air compressor based on a second RPM higher than the first RPM, identifying a second sensing value for measuring the flow rate of the air supplied to the fuel cell stack by using the flow rate sensor during a second time during which an RPM of the air compressor decreases from the second RPM to the first RPM by temporarily stopping driving of the air compressor, obtaining a third amount of change in the temperature of the coolant and a fourth amount of change in the temperature of the air compressor by using the temperature sensor, obtaining a second flow rate value representing the flow rate of the air to be supplied to the fuel cell stack based on the third amount of change and the fourth amount of change during the second time, and mapping the second sensing value to the second flow rate value.

For example, the method may further include starting to drive the air compressor based on the first RPM after the second time, and checking whether the first sensing value is mapped to the first flow rate value while driving the air compressor based on the first RPM.

For example, the obtaining of the third amount of change and the fourth amount of change may include obtaining the third amount of change by using at least one of an outside temperature, the temperature of the coolant, the second time, or a combination thereof, and obtaining the fourth amount of change by using at least one of the outside temperature, the temperature of the air compressor, the second time, or a combination thereof.

For example, the obtaining of the second flow rate value may further include obtaining a third flow rate value representing the flow rate of the air supplied to the fuel cell stack by using the third amount of change, obtaining a fourth flow rate value representing the flow rate of the air supplied to the fuel cell stack by using the fourth amount of change, and obtaining the second flow rate value including an average value of the third flow rate value and the fourth flow rate value.

For example, the obtaining of the first amount of change and the second amount of change may include obtaining the first amount of change by using at least one of an outside temperature, the temperature of the coolant, a heat generation amount based on driving of the air compressor, the first time, or a combination thereof, and obtaining the second amount of change by using at least one of the outside temperature, the temperature of the air compressor, the first time, or a combination thereof.

For example, the obtaining of the first flow rate value further may include obtaining a fifth flow rate value representing the flow rate of the air supplied to the fuel cell stack by using the first amount of change, obtaining a sixth flow rate value representing the flow rate of the air supplied to the fuel cell stack by using the second amount of change, and obtaining the first flow rate value including an average value of the fifth flow rate value and the sixth flow rate value.

For example, the identifying of the first sensing value may include identifying the first sensing value for measuring the flow rate of the air by using the flow rate sensor adjacent to an outside of the vehicle control apparatus of the outside of the vehicle control apparatus and the fuel cell stack.

For example, the identifying of the first sensing value may include identifying the first sensing value based on that an air intake system including the air compressor is first coupled to the vehicle control apparatus.

For example, the method may further include identifying the first sensing value corresponding to the first RPM if diagnosing a state of the air intake system, obtaining a seventh flow rate value representing the flow rate of the air supplied to the fuel cell stack by using the first amount of change and the second amount of change, comparing the first flow rate value and the seventh flow rate value based on that the first sensing value is mapped to the seventh flow rate value, identifying the state of the air intake system as a normal state if the first flow rate value is equal to the seventh flow rate value or a difference between the first flow rate value and the seventh flow rate value is within a preset range, and identifying the state of the air intake system as a failure state if the first flow rate value is different from the seventh flow rate value or the difference between the first flow rate value and the seventh flow rate value is outside the preset range.

The present technology may identify the flow rate of air provided to the fuel cell stack.

The present technology may tune the sensing value identified using a flow rate sensor to the flow rate value representing the flow rate of air.

In addition, the present technology may diagnose the state of the air intake system for supplying air to the fuel cell stack.

In addition, various effects that are directly or indirectly understood through the present disclosure may be provided.

Although examples of the present disclosure have been described for illustrative purposes, those skilled in the art will appreciate that various modifications, additions and substitutions are possible, without departing from the scope and spirit of the disclosure.

Therefore, the examples disclosed in the present disclosure are provided for the sake of descriptions, not limiting the technical concepts of the present disclosure, and it should be understood that such examples are not intended to limit the scope of the technical concepts of the present disclosure. The protection scope of the present disclosure should be understood by the claims below, and all the technical concepts within the equivalent scopes should be interpreted to be within the scope of the right of the present disclosure.

What is claimed is:

1. A vehicle control apparatus comprising:
one or more processors;
a memory storing instructions;
a fuel cell stack;
an air compressor;
a temperature sensor; and
a flow rate sensor,
wherein the instructions, when executed by the one or more processors, configured the one or more processors to:
determine, based on first data, from the flow rate sensor, associated with air supplied to the fuel cell stack via the air compressor driven at a first revolutions per minute (RPM) during a first time, a first sensing value for measuring a flow rate of air and corresponding to the first RPM;
determine, based on second data, from the temperature sensor, collected during the first time:
a first amount of change in a temperature of a coolant flowing via a cooler, and
a second amount of change in a temperature of the air compressor;
determine, based on the first amount of change in the temperature of the coolant and the second amount of change in the temperature of the air compressor, a first flow rate value representing the flow rate of the air supplied to the fuel cell stack; and
map the first sensing value to the first flow rate value.

2. The vehicle control apparatus of claim 1, wherein the instructions, when executed by the one or more processors, further configured the one or more processors to:
after driving the air compressor at a second RPM higher than the first RPM, stop driving of the air compressor;
determine, based on third data from the flow rate sensor, a second sensing value for measuring the flow rate of the air supplied to the fuel cell stack, wherein the third data is associated with a second time during which an RPM of the air compressor decreases from the second RPM to the first RPM based on the stopping the driving of the air compressor;
determine, based on fourth data, from the temperature sensor, collected during the second time:
a third amount of change in the temperature of the coolant, and
a fourth amount of change in the temperature of the air compressor;
determine, based on the third amount of change and the fourth amount of change, a second flow rate value representing the flow rate of the air to be supplied to the fuel cell stack; and
map the second sensing value to the second flow rate value.

3. The vehicle control apparatus of claim 2, wherein the instructions, when executed by the one or more processors, further configured the one or more processors to:
drive, after the second time, the air compressor at the first RPM; and
check, while driving the air compressor at the first RPM after the second time, whether the first sensing value is mapped to the first flow rate value.

4. The vehicle control apparatus of claim 2, wherein the instructions, when executed by the one or more processors, further configure the one or more processors to:
determine the third amount of change based on at least one of: an outside temperature, the temperature of the coolant, or the second time; and
determine the fourth amount of change based on at least one of: the outside temperature, the temperature of the air compressor, or the second time.

5. The vehicle control apparatus of claim 4, wherein the instructions, when executed by the one or more processors, further configure the one or more processors to:
determine, based on the third amount of change, a third flow rate value representing the flow rate of the air supplied to the fuel cell stack;
determine, based on the fourth amount of change, a fourth flow rate value representing the flow rate of the air supplied to the fuel cell stack; and
determine, based on an average of the third flow rate value and the fourth flow rate value, the second flow rate value.

6. The vehicle control apparatus of claim 1, wherein the instructions, when executed by the one or more processors, further configure the one or more processors to:
determine the first amount of change based on at least one of: an outside temperature, the temperature of the coolant, a heat generation amount associated with the air compressor, or the first time; and
determine the second amount of change based on at least one of: the outside temperature, the temperature of the air compressor, or the first time.

7. The vehicle control apparatus of claim 6, wherein the instructions, when executed by the one or more processors, further configure the one or more processors to:
determine, based on the first amount of change, a fifth flow rate value representing the flow rate of the air supplied to the fuel cell stack;
determine, based on the second amount of change, a sixth flow rate value representing the flow rate of the air supplied to the fuel cell stack; and
determine, based on an average of the fifth flow rate value and the sixth flow rate value, the first flow rate value.

8. The vehicle control apparatus of claim 1, wherein the flow rate sensor is adjacent to an outside of the vehicle control apparatus relative to the fuel cell stack.

9. The vehicle control apparatus of claim 1, further comprising an air intake system coupled to the air compressor.

10. The vehicle control apparatus of claim 9, wherein the one or more processors are configured to:
determine, based on diagnosing a state of the air intake system, the first sensing value corresponding to the first RPM;
determine, based on the first amount of change and the second amount of change, a seventh flow rate value representing the flow rate of the air supplied to the fuel cell stack;
compare, based on that the first sensing value being mapped to the seventh flow rate value, the first flow rate value and the seventh flow rate value; and
based on the comparing:
identify, based on a difference between the first flow rate value and the seventh flow rate value being within a preset range, the state of the air intake system as a normal state; or
identify, based on the difference being outside of the preset range, the state of the air intake system as a failure state.

11. A method comprising:
determining, by a vehicle control apparatus based on first data, from a flow rate sensor, associated with air supplied to a fuel cell stack via an air compressor driven at a first revolutions per minute (RPM) during a first time, a first sensing value for measuring a flow rate of air corresponding to the first RPM;
determining, based on second data, from a temperature sensor, collected during the first time:
a first amount of change in a temperature of a coolant flowing via a cooler, and
a second amount of change in a temperature of the air compressor;
determining, based on the first amount of change in the temperature of the coolant and the second amount of change in the temperature of the air compressor, a first flow rate value representing the flow rate of the air supplied to the fuel cell stack;
mapping the first sensing value to the first flow rate value; and
controlling, by the vehicle control apparatus based on the mapping of the first sensing value to the first flow rate value, air flow, to the fuel cell stack, via the air compressor.

12. The method of claim 11, further comprising:
after driving the air compressor at a second RPM higher than the first RPM, stopping driving of the air compressor;
determining, based on third data from the flow rate sensor, a second sensing value for measuring the flow rate of the air supplied to the fuel cell stack, wherein the third data is associated with a second time during which an RPM of the air compressor decreases from the second RPM to the first RPM based on the stopping the driving of the air compressor;
determining, based on fourth data, from the temperature sensor, collected during the second time:
a third amount of change in the temperature of the coolant, and
a fourth amount of change in the temperature of the air compressor;
determining, based on the third amount of change and the fourth amount of change a second flow rate value representing the flow rate of the air to be supplied to the fuel cell stack; and
mapping the second sensing value to the second flow rate value.

13. The method of claim 12, further comprising:
driving the air compressor at the first RPM after the second time; and
checking, while driving the air compressor at the first RPM after the second time, whether the first sensing value is mapped to the first flow rate value.

14. The method of claim 12, wherein:
the determining the third amount of change is based on at least one of: an outside temperature, the temperature of the coolant, or the second time; and
the determining the fourth amount of change is based on at least one of: the outside temperature, the temperature of the air compressor, or the second time.

15. The method of claim 14, further comprising:
determining, based on the third amount of change, a third flow rate value representing the flow rate of the air supplied to the fuel cell stack; and
determining, based on the fourth amount of change, a fourth flow rate value representing the flow rate of the air supplied to the fuel cell stack, wherein the determining the second flow rate value is based on an average of the third flow rate value and the fourth flow rate value.

16. The method of claim 11, wherein:
the determining the first amount of change is based on at least one of: an outside temperature, the temperature of the coolant, a heat generation amount based on driving of the air compressor, or the first time; and
the determining the second amount of change is based on at least one of: the outside temperature, the temperature of the air compressor, or the first time.

17. The method of claim 16, further comprising:
determining, based on the first amount of change, a fifth flow rate value representing the flow rate of the air supplied to the fuel cell stack; and
determining, based on the second amount of change, a sixth flow rate value representing the flow rate of the air supplied to the fuel cell stack, wherein the determining the first flow rate value is based on an average of the fifth flow rate value and the sixth flow rate value.

18. The method of claim 11, wherein the vehicle control apparatus comprises the flow rate sensor and the fuel cell stack, and wherein the flow rate sensor is adjacent to an outside of the vehicle control apparatus relative to the fuel cell stack.

19. The method of claim 11, wherein the determining the first sensing value is based on an air intake system coupled to the vehicle control apparatus.

20. The method of claim 19, further comprising:
determining, based on diagnosing a state of the air intake system, the first sensing value corresponding to the first RPM;
determining, based on the first amount of change and the second amount of change, a seventh flow rate value representing the flow rate of the air supplied to the fuel cell stack;
comparing, based on the first sensing value being mapped to the seventh flow rate value, the first flow rate value and the seventh flow rate value; and
based on the comparing:
identifying, based on a difference between the first flow rate value and the seventh flow rate value being with a preset range, the state of the air intake system as a normal state; or
identifying, based on the difference being outside of the preset range, the state of the air intake system as a failure state.
